(19) United States
(12) Patent Application Publication
(10) Pub. No.: US 2002/0134256 A1
(43) Pub. Date: Sep. 26, 2002

(54) Booster and press working device

(76) Inventors: Shoji Futamura, Atsugi-shi (JP); Hiromitsu Kaneko, Yokohama-shi (JP)

Correspondence Address: McGlew & Tuttle, Scarborough Station, Scarborough, NY, 10510-0827, US

(21) Appl. No.: 09/980,367

(22) PCT Filed: Apr. 24, 2001
(86) PCT No.: PCT/JP01/03496

(30) Foreign Application Priority Data
Apr. 27, 2000 (JP) 126791/2000
Jul. 21, 2000 (JP) 220362/2000
Nov. 15, 2000 (JP) 347427/2000

(51) Int. Cl. B30B 1/23; B30B 1/32

(52) U.S. Cl. 100/269.01

(57) ABSTRACT

The press working apparatus of the present invention is adapted so that the apparatus moves at a large moving speed in a first stroke stage before the press working of a workpiece, and a large pressing force is produced at a second stroke stage at which the workpiece is about to be pressed.

The press working apparatus has a first cylinder of a small diameter, and a second cylinder of a large diameter; the moving speed of a first piston in the first cylinder is made substantially equal to the moving speed of a second piston in the second cylinder in the first stroke stage, and the pressing force exerted onto the workpiece is made larger by the movement of the second piston in accordance with Pascal's law.

### FIELD OF THE INVENTION

The present invention relates generally to a pressure booster and a press working apparatus having the pressure booster for use in press working, such as sheet metal working and sheet metal punching, and more particularly to a pressure booster and a press working apparatus capable of imparting a great actuating force to a presswork unit while maintaining a relatively large stroke by the use of a combination of a reciprocating drive means and a hydraulic cylinder.

### BACKGROUND ART

Heretofore, fluid hydraulic cylinders, particularly oil hydraulic cylinders, have been widely used as means for driving a movable punch of a presswork unit having movable and fixed dies in a press working apparatus. When imparting a large actuating force to the presswork unit in a hydraulic cylinder-operated press working apparatus, a pressure boosting means relying on Pascal's principle has been widely used.

FIG. 14 is a diagram of assistance in explaining an example of a pressure boosting means that have heretofore been in wide use. In FIG. 14, a plunger 301 and a piston 302 are mounted on a hydraulic cylinder 300. An actuating force is imparted to a prescribed presswork unit by the piston 302 and a piston rod 303 connected thereto. Assuming that cross-sectional areas of the plunger 301 and the piston 302 are A₁ and A₂, respectively, giving a force P₁ to the plunger 301 yields an actuating force P₂=P₁·A₂/A₁ on the piston rod 303.

In a pressure boosting means as shown in FIG. 14 above, a large actuating force P₂ can be obtained by increasing the ratio of A₂/A₁. With a plunger 301 and a piston 302 having diameters of 40 mm and 160 mm, respectively, an actuating force of P₂=16 P₁ can be produced on the piston rod 303, and if P₁=7 t, for example, an actuating force as large as 112 t can be produced (P₂=7×16=112 t). Thus, a large actuating force can be obtained on the piston rod 303 that drives the presswork unit by driving the plunger 301 with a relatively small force.

The aforementioned pressure boosting means, however, has a shortcoming of having too short a stroke of the piston rod 303, whereas it yields a large actuating force. If the plunger 301 and the piston 302 have the aforementioned dimensions, moving the plunger 301 200 mm, for example, gives a stroke of only 200×1/16=12.5 mm to the piston rod 303.

The presswork unit in a press working apparatus usually has to load and discharge a workpiece in between the movable and fixed dies. If the stroke of the movable die that is actuated by the piston rod 303, as described above, is as short as 12.5 mm, for example, the stroke of the movable die falls short of the prescribed movement needed for deep drawing, for example, not to speak of punching or piercing a flat workpiece.

Further increasing the stroke of the plunger 301 to increase the stroke of the movable die would require not only the larger size of the pressure boosting means but also the prolonged tact time, making the press working operation impracticable. Another possible method to maintain the stroke of the piston rod 303 is to supply an additional amount of hydraulic operating fluid into the hydraulic cylinder 300 above the piston 302. With this method, however, an additional hydraulic unit, including a hydraulic pump, would have to be provided and energy consumption would be unwantedly increased.

### DISCLOSURE OF THE INVENTION

The present invention is intended to overcome the aforementioned problems inherent in the prior art, and it is an object of the present invention to provide a pressure booster and press working apparatus that can impart a large actuating force to a presswork unit, while maintaining a relatively large stroke.

To achieve these objectives, we utilize in the first invention a pressure booster using a hydraulic operating fluid comprising

a first cylinder and a second cylinder having a larger cross-sectional area than that of the first cylinder;

the first cylinder and the second cylinder formed in such a manner as to communicate with each other;

a first piston slidably fitted to the first cylinder;

a second piston slidably fitted to the second cylinder;

the shape of the downstream-side surface of the first piston and/or the upstream-side surface of the second piston being formed in such a manner that hydraulic pressure is exerted via the hydraulic operating fluid only onto part of the upstream-side surface of the second piston during the period in which the downstream-side surface of the first piston moves within unit of time in the first stroke stage where the first piston is caused to move; and

hydraulic pressure is exerted via the hydraulic operating fluid onto the virtually entire surface of the upstream-side surface of the second piston corresponding to the cross-sectional area of the second cylinder during the period in which the downstream-side surface of the first piston moves within unit of time in the second stroke stage where the first piston is caused to move.

In the second invention, we use a pressure booster using a hydraulic operating fluid comprising

a first cylinder and a second cylinder having a cross-sectional area larger than that of the first cylinder;

the first cylinder and the second cylinder formed in such a manner as to communicate with each other;

a first piston slidably fitted to the first cylinder;

a second piston slidably fitted to the second cylinder;

the hydraulic operating fluid being supplied in a cavity on the upstream-side surface of the second piston corresponding to a size in which the volume produced as the upstream-side surface of the second piston moves within unit of time becomes larger than the volume produced as the downstream-side surface of the first piston moves within unit of time in the first stroke stage where the first piston is caused to move;

the cavity contacting with the downstream-side surface of the first piston being communicated with the cavity contacting with the upstream-side surface of the second piston and the operating fluid in both the cavities being sealed so that the volume produced as the downstream-side surface of the first piston moves within unit of time becomes virtually the same as the volume produced as the upstream-side surface of the second piston moves within unit of time in the second stroke stage where the first piston is caused to move.

More specifically, a first embodiment of press working apparatus employs a technical means which is a press working apparatus with a pressure booster mounted on a base plate and driven by a drive means;

the pressure booster comprising a hydraulic cylinder, a plunger fitted to the hydraulic cylinder and formed movably in the axial direction of the hydraulic cylinder, and a bottomed hollow actuating piston;

an end of the plunger being connected to the drive means;

the bottom end of the actuating piston being protruded from the end of the hydraulic cylinder and engaged with a workpiece being pressed;

a projection having a smaller axial length than the stroke of the actuating piston being provided at the center of an open end of the actuating piston; the projection being engaged slidably with a sliding part provided on part of the inside surface of the hydraulic cylinder, with no space therebetween, and formed into essentially the same axial length as the axial length of the projection; and

the plunger provided in such a manner as to be advanced into the hollow part of the actuating piston via a gap;

so that the workpiece is pressed via the plunger, the fluid in the hydraulic cylinder and the actuating piston by driving the plunger and the piston by the movement of the drive means toward the workpiece being pressed.

To achieve the aforementioned objectives, the second embodiment of the present invention employs a technical means in which

a pressure booster comprises a first cylinder and a second cylinder having a larger cross-sectional area than that of the first cylinder, with both cylinders communicating with each other;

a first piston slidably fitted to the first cylinder;

a second piston slidably fitted to the second cylinder;

a projection having an axial length smaller than the stroke of the first piston being provided integrally with the second piston, with the projection slidably engaged with the first cylinder, with no cavity therebetween;

so that an actuating force larger than that of the first piston is exerted to the second piston by the operation of the first piston via the operating fluid in the first and second cylinders.

Furthermore, the third embodiment of the present invention employs a technical means in which

the pressure booster comprises an actuating cylinder, a pump cylinder, a plunger and an actuating piston fitted to the actuating cylinder, facing each other, and a pump piston fitted to the pump cylinder;

an end of the plunger being connected to the rod of the pump piston;

the rod of the actuating piston being formed in such a manner that the actuating piston rod can be engaged with a workpiece being pressed;

the plunger and the pump piston being driven by the movement of the drive means toward the workpiece being pressed; and

the operating fluid being provided in the actuating cylinder in such a manner as to allow to flow, or prevent from flowing, in the actuating cylinder;

so that the workpiece being pressed can be pressed via the plunger, the operating fluid in the actuating cylinder and the actuating piston.

### BRIEF DESCRIPTION OF THE DRAWINGS

FIG. 1 is a front view showing the essential part of a first embodiment of the present invention.

FIG. 2 is an enlarged longitudinal sectional view showing the essential part of a pressure booster in the first embodiment.

FIG. 3 is a front view showing the essential part of a second embodiment of the present invention.

FIG. 4 is an enlarged longitudinal sectional view showing the essential part of a pressure booster in the second embodiment.

FIG. 5 is a diagram of assistance in explaining the operating state of the pressure booster in the second embodiment.

FIG. 6 is a diagram of assistance in explaining the operating state of the pressure booster in the second embodiment.

FIG. 7 is a diagram of assistance in explaining the operating state of the pressure booster in the second embodiment.

FIG. 8 is a diagram of assistance in explaining the operating state of the pressure booster in the second embodiment.

FIG. 9 is a diagram of assistance in explaining the operating state of the pressure booster in the second embodiment.

FIG. 10 is a diagram of assistance in explaining the operating state of the pressure booster in the second embodiment.

FIG. 11 is a front view showing a third embodiment of the present invention.

FIG. 12 is an enlarged longitudinal sectional view showing a pressure booster in the third embodiment.

FIG. 13 is a cross-sectional view taken along line A-A in FIG. 12.

FIG. 14 is a diagram showing an example of a pressure boosting means that has heretofore been widely used.

### BEST MODE IN CARRYING OUT THE INVENTION

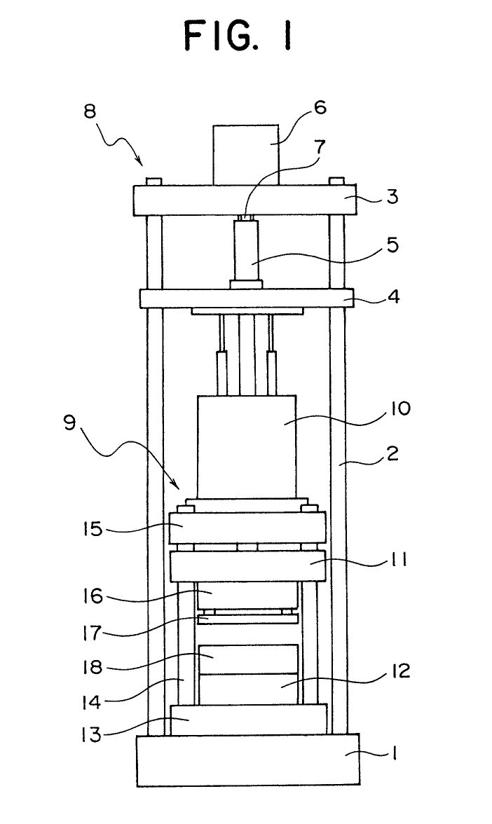

FIG. 1 is a front view showing the essential part of a first embodiment of the present invention. In FIG. 1, guide bars 2 are provided upright at four corners of a base plate 1 of a rectangular shape, for example. At the upper ends of the guide bars 2 fixedly fitted is a support plate 3 with appropriate fastening means. Numeral 4 refers to a slider vertically slidably mounted on the guide bars 2. Numeral 5 refers to a nut member integrally provided on the central upper surface of the slider 4, screwed to a threaded shaft 7 connected to the main shaft of a servo motor 6 provided on the upper surface of the support plate 3. In this case, the threaded shaft 7 and the nut member 5 should preferably be of a ball-screw arrangement. The above construction constitutes a main body 8 of the press working apparatus.

Numeral 9 refers to a presswork unit comprising a pressure booster 10, which has such a construction as will be described later, a movable die 11 and a fixed die 12, both of which are detachably installed between the base plate 1 and the slider 4. The presswork unit 9 has such a construction that a presswork unit support plate 15 is fixedly fitted on the upper ends of presswork unit guide bars 14 provided at four corners of a presswork unit base plate 13 of a rectangular shape, for example, with a pressure booster 10 provided on the presswork unit support plate 15.

The pressure booster 10 is driven by the vertical movement of the slider 4, as will be described later, to actuate the movable die 11. The movable die 11 may be of such a construction as to be upwardly preloaded at all times by the use of a spring (not shown), for example, or other appropriate means. On the movable and fixed dies 11 and 12 detachably provided are a punch pad 16, a stripper 17 and a die 18, for example.

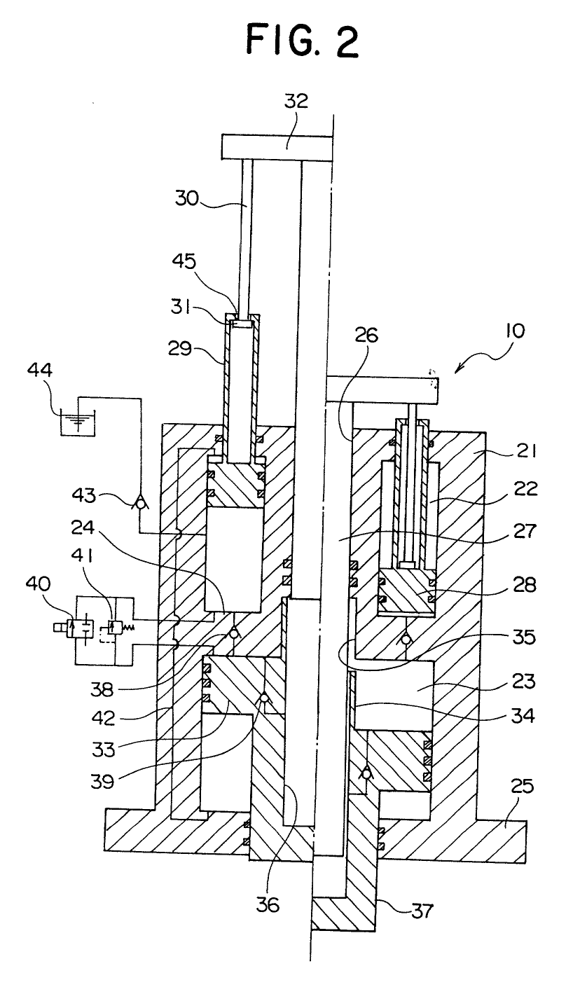

FIG. 2 is an enlarged longitudinal sectional view showing the essential part of the pressure booster in the first embodiment of the present invention, the left side of the central line thereof showing the state where a movable member is at the top dead-center position thereof, and the right side showing the state where the movable member is at the bottom dead-center position thereof. In FIG. 2, numeral 21 refers to a hydraulic cylinder formed into a hollow cylindrical shape. The hydraulic cylinder 21 has such a construction that a cylinder cavity 22 having a ring-shaped cross section, for example, is provided on the upper part thereof and a cylinder cavity 23 of a normal cylindrical shape provided on the lower part thereof; both cavities 22 and 23 separated by a bulkhead 24. Numeral 25 refers to a mounting flange.

Next, a hole 26 having an equal inside diameter is provided at the upper center of the hydraulic cylinder 21, and a plunger 27 having an equal outside diameter is vertically slidably inserted in the hole 26. The plunger 27 corresponds to a first piston referred to in the present invention. Inside the cylinder cavity 22 vertically movably provided is a piston 28 of a ring shape, for example. On the upper end face of the ring-shaped piston 28 integrally provided are four tubular rods 29, for example, arranged at equal intervals in the circumferential direction. These tubular rods 29 are formed in such a manner as to protrude upward from the upper end face of the hydraulic cylinder 21.

Numeral 30 refers to a driving rod provided inside the tubular rod 29 in such a manner as to be relatively movably in the axial direction of the tubular rod 29. At the lower end of the driving rod 30 provided is a driving element 31. The ring-shaped piston 28 is adapted to be vertically movable as the driving element 31 comes in contact with a stopper 45 on the upper end of the tubular rod 29 and with the upper end face of the ring-shaped piston 28. The upper ends of the plunger 27 and the driving rod 30 are connected integrally to a plate 32. The plate 32 is also connected to the slider 4 shown in FIG. 1 above.

Next, a bottomed hollow actuating piston 33 is vertically movably provided inside the cylinder cavity 23 provided at the lower part of the hydraulic cylinder 21. On the central upper end face of the actuating piston 33 provided is a protruding part 34 that is formed in such a manner as to vertically slidable with a sliding part 35 provided above the cylinder cavity 23, with no cavity therebetween. The axial length of the protruding part 34 and the sliding part 35 is made substantially equal and smaller than the stroke of the actuating piston 33.

The inside diameter of the cavity 36 of the actuating piston 33 is made slightly larger than the outside diameter of the plunger 27 so that the plunger 27 can go into the cavity 36 via a gap. The bottom end 37 of the actuating piston 33 is formed in such a manner as to protrude downward from the bottom end of the hydraulic cylinder 21 so that the bottom end 37 can be engaged with the movable die 11 of the presswork unit 9 shown in FIG. 1. O rings, packing and other appropriate sealing means are provided around sliding parts of the plunger 27, the ring-shaped piston 28, the tubular rod 29, the actuating piston 33 and the hydraulic cylinder 21.

Numerals 38 and 39 refer to check valves each provided for the bulkhead 24 and the actuating piston 33 so as to allow the hydraulic oil inside the hydraulic cylinder 21 to flow only in the direction from the cylinder cavity 22 to the cylinder cavity 23, and only in the direction from the cylinder cavity 23 to the cavity 36 of the actuating piston 33. A changeover valve 40 and a pressure regulating valve 41 are provided side in parallel with each other between the cylinder cavity 22 and the cylinder cavity 23. A flow path 42 is provided between the upper end of the cylinder cavity 22 and the lower end of the cylinder cavity 23 so that the hydraulic oil inside both cavities 22 and 23 can flow between both. The cylinder cavity 22 is connected to the hydraulic oil tank 44 via a check valve 43.

With the above construction, when the screw shaft 7 is rotated by actuating the servo motor 6 shown in FIG. 1, the slider 4 is moved downward via the nut member 5 screwed to the screw shaft 7. That is, as the plate 32 connected to the slider 4 shown in FIG. 1 is moved downward in FIG. 2, the plunger 27 and the driving rod 30 are also moved downward.

When the plunger 27 is moved downward from the state shown on the left side of the center line in FIG. 2, the plunger 27 enters the cavity 36 of the actuating piston 33. In this case, the hydraulic oil in the cavity 36 is tightly sealed since the protruding part 34 provided on the upper end of the actuating piston 33 is closely engaged with the sliding part 35 extending upward from the cylinder cavity 23. The actuating piston 33 is therefore moved downward almost in synchronism with the plunger 27 as the plunger 27 enters the cavity 36 of the plunger 27.

With the downward movement of the actuating piston 33, the hydraulic oil in the cylinder cavity 22 is supplied to the cylinder cavity 23 above the actuating piston 33 through the check valve 38. The hydraulic oil in the cylinder cavity 23 below the actuating piston 33, on the other hand, flows into the cylinder cavity 22 above the ring-shaped piston 28 through the flow path 42. Thus, the actuating piston 33 is smoothly moved downward while the ring-shaped piston 28 is also moved downward as the result of the flow of the hydraulic oil. In this case, it is assumed that the changeover valve 40 is in the closed state and the flow of the hydraulic oil from the cylinder cavity 22 to the cylinder cavity 23 is only via the check valve 38. That is, the bottom end 37 of the actuating piston 33 descends at the same speed as the descending speed of the plunger 27.

Next, When the upper end of the protruding part 34 moves away from the lower end of the sliding part 35 as the actuating piston 33 moves further downward, the pressure of the plunger 27 to the hydraulic oil is exerted over the entire upper end surface of the actuating piston 33. As a result, the descending speed of the bottom end 37 becomes sufficiently lower than the descending speed of the actuating piston 33. Thus, an actuating force corresponding to the ratio of cross-sectional surface areas of both can be imparted to the actuating piston 33. That is, the movable die 11 shown in FIG. 1 can be operated with a predetermined actuating force via the bottom end 37.

Since the speed at which the plunger 27 enters the cavity 36 of the actuating piston 33 is lower than the descending speed of the actuating piston 33 and the ring-shaped piston 28 corresponding to the ratio of the respective cross-sectional areas thereof, the driving rod 30 enters the tubular rod 29, and the driving element 31 comes in contact with the upper end of the ring-shaped piston 28, thereby pressing the ring-shaped piston 28. The right side of the center line of FIG. 2 shows the state where the plunger 27, the actuating piston 33 and the ring-shaped piston 28 reach the lower end of the respective strokes thereof, at which the prescribed press working is completed.

Next, the state where each of the movable members is returned from the lower end position to the original upper end position will be described. When the plunger 27 is moved upward by changing the changeover valve 40 to the open state, the hydraulic oil flows into the cavity in the cylinder cavity 22 below the piston 28 via the changeover valve 40. As a result, the actuating piston 33 is moved upward since the hydraulic pressure in the cavity 36 of the actuating piston 33 and the cylinder cavity 23 above the actuating piston 33 drops. In this case, the moving speed of the actuating piston 33 is naturally lower than the moving speed of the bottom end 37 in accordance with the ratio of the cross-sectional areas of both.

That is, the hydraulic oil in the cylinder cavity 23 above the actuating piston 33 flows into the cylinder cavity 22 below the ring-shaped piston 28 via the changeover valve 40 as the result of the upward movement of the actuating piston 33, while the hydraulic oil in the cylinder cavity 22 above the ring-shaped piston 28 flows into the cylinder cavity 23 below the actuating piston 33 via the flow path 42. The driving rod 30 is also moved upward in the tubular rod 29 simultaneously with the upward movement of the plunger 27 (because the ascending speed of the plunger 27 is higher than the ascending speed of the ring-shaped piston 28 due to the difference of cross-sectional area between the plunger 27 and the ring-shaped piston 28). With the upward movement of the actuating piston 33, the ring-shaped piston 28 also moves upward at almost the same speed as that of the actuating piston 33.

As the actuating piston 33 ascends and the upper end of the protruding part 34 provided on the upper end of the actuating piston 33 reaches the lower end of the sliding part 35, the cavity 36 of the actuating piston 33 is brought into the sealed state. Thus, the hydraulic oil in the cylinder cavity 23 above the actuating piston 33 is fed to the inside of the cavity 36 of the actuating piston 33 via the check valve 39 as the result of the further upward movement of the plunger 27. After that, the actuating piston 33 moves upward almost in synchronism with the plunger 27.

Since the driving rod 30 also moves upward, together with the plunger 27, the driving element 31 provided on the lower end of the driving rod 30 is engaged with the engaging part 45 provided on the upper end of the tubular rod 29, thereby pulling up the ring-shaped piston 28 via the tubular rod 29. In this way, each of the actuating members are returned to the original upped-end position as shown at the left of the centerline in FIG. 2.

The pressure booster 10 having the aforementioned construction, which circulate an appropriate amount of hydraulic oil inside thereof, requires virtually no hydraulic oil to be supplied from the outside. In practice, however, it is recommended to make up for some loss due to leaks by feeding an appropriate amount of hydraulic oil from the hydraulic oil tank 44 into the cylinder cavity 22 via the check valve 43. The hydraulic pressure for operating the actuating piston 33 by the plunger 27 can be adjusted by the pressure regulating valve 41. The ring-shaped piston 28, which has a pumping action, moves up and down in conjunction with the up and down movement of the actuating piston 33. The ring-shaped piston 28 can be operated more positively by providing the tubular rod 29 and the driving rod 30.

Although description has been made about an example of the hydraulic cylinder operated by hydraulic oil in the above first embodiment, water and other fluid media may be used for the hydraulic cylinder. Furthermore, although description has been made about the so-called vertical type in which the base plate 1 and the support plate 3 are disposed in parallel with the horizontal plane, with the guide bar 2 connecting both provided in the vertical direction, the present invention can be applied to the so-called horizontal type where the base plate 1 and the support plate 3 are disposed in parallel with the vertical plane, with the guide bar 2 provided in the horizontal direction.

Although the present invention is particularly effective for the construction where the threaded shaft 7 and the nut member 5 are connected with a ball-screw engagement, the present invention can also be applied to a construction where both are connected with a standard screw engagement. Needless to say, the threaded shaft 7 may be of a multiple-start type, including the ball-screw engagement. Although the most common configuration is such that the servo motor 6 for driving the threaded shaft 7 is coaxially connected directly to the threaded shaft 7 is most common, drive force may be transmitted with gears, timing belts and other transmission means.

In the above embodiment, description has been made about the construction where the threaded shaft 7 is driven to move the slider 4. There can be a construction, however, where the threaded shaft 7 is fixedly fitted to the slider 4, and the nut member 5 screwed to the threaded shaft 7 is driven by the servo motor 6. A crank mechanism may be used as means for driving the slider 4.

Furthermore, the guide bar 2 for guiding the movement of the slider 4 should preferably be more than one for large machines or those requiring rigidity, but a single piece of guide bar 2 may serve the purpose. The guide bar 2 may be formed into a columnar or beam shape, or may have such a construction that the slider 4 slides along the side surface of the guide bar 2.

In addition, the press working apparatus of the present invention that is originally used singly, can be applied to an indexing machining of a long-sized workpiece, for example, by disposing a plurality of the press working apparatuses in tandem. The press working apparatus of the present invention can be used for assembling, press-fitting and crimping a plurality of parts, in addition to the sheet metal working of sheet materials.

The first embodiment of the present invention has the following effects:

1) The stroke of the movable die needed for the presswork unit can be made relatively larger. This permits the movable die to move at relatively higher speed within the moving range in which a small actuating force serves the purpose, thereby imparting a large actuating force between relatively short strokes at the final stage.

2) A very small quantity of hydraulic oil, for example, is required to operate the apparatus, and very small energy consumption is required since there is no need for supplying high-pressure hydraulic oil to the hydraulic unit, etc.

The aforementioned first embodiment has such a construction that the cavity 36 and the protruding part 34 are provided on the actuating piston 33. The actuating piston 33 can descend at the same descending speed as the descending speed of the plunger 27 until the protruding part 34 clears the bottom end of the sliding part 35 extending continuously toward the upper part of the cylinder cavity 23. As the protruding part 34 has cleared the bottom end of the sliding part 35, the descending speed of the actuating piston 33 becomes sufficiently lower than the descending speed of the plunger 27. Thus, the actuating force for pressing the movable die 11 shown in FIG. 1 via the bottom end 37 of the actuating piston 33 can be made sufficiently large.

The second embodiment of the present invention, however, has such a construction that the cavity 36, the protruding part 34 and the sliding part 35 used in the first embodiment are omitted.

In the following, the second embodiment will be described.

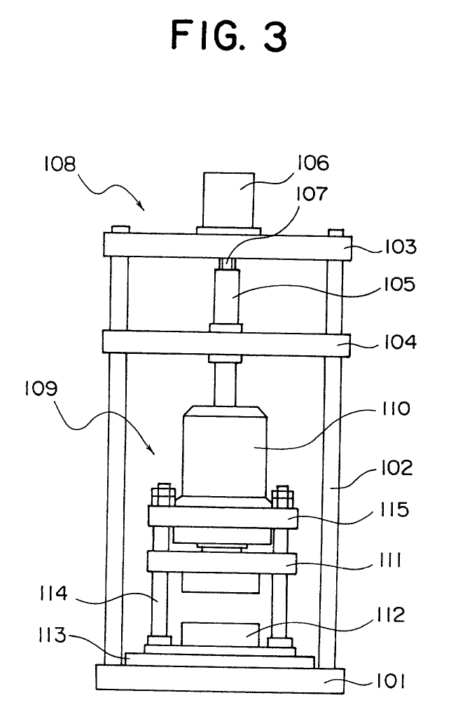

FIG. 3 is a front view showing the essential part of the second embodiment of the present invention. In FIG. 3, too, guide bars 102 are provided upright at the four corners of a base plate 101 formed into a rectangular shape, for example, and a support plate 103 is fixedly fitted to the upper ends of the guide bars 102 via appropriate fastening means. Numeral 104 refers to a slider vertically slidably provided on the guide bars 102. Numeral 105 refers to a nut member integrally provided on the central upper surface of the slider 104 and engaged with a threaded shaft 107 connected to the main shaft of a servo motor 106 provided on the upper surface of the support plate 103. In this case, the threaded shaft 107 and the nut member 105 should preferably constitute a ball-screw mechanism. These components arranged in the aforementioned construction constitute the body 108 of the press working apparatus.

Next, numeral 109 refers to a presswork unit having a pressure booster 110 whose construction will be described later, a movable die 111 and a fixed mold 112, both detachable provided between the base plate 101 and the slider 104. The presswork unit 109 has such a construction that a presswork unit support plate 115 is fixedly fitted on the upper ends of presswork unit guide bars 114 provided upright at the four corners of a presswork unit base plate 113 formed into a rectangular shape, for example, and a pressure booster 110 is provided on the presswork unit support plate 115.

The pressure booster 110 is driven by the vertical movement of the slider 104, as will be described later, to operate the movable die 111. The movable die 111 may be adapted to be preloaded upward by a spring (not shown), for example, or other appropriate means. A punch pad and a stripper, and dies (all of which are not shown in the figure), for example, are detachably provided on the movable die 111 and the fixed die 112.

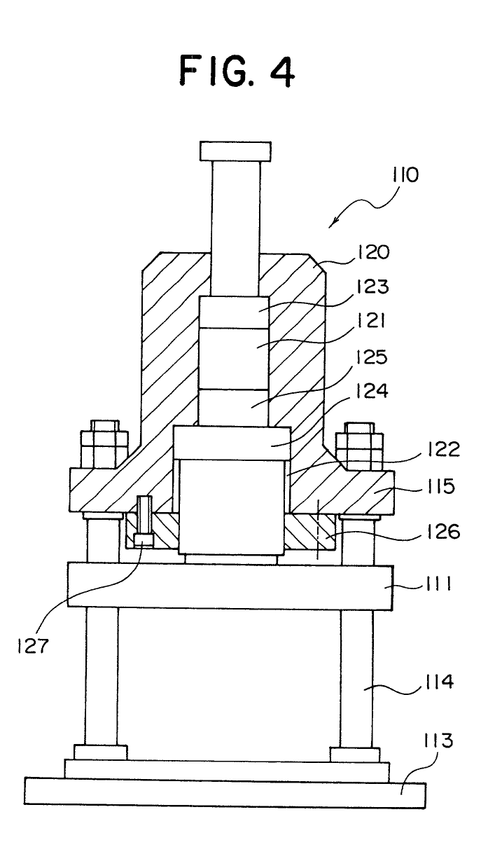

FIG. 4 is an enlarged longitudinal sectional view showing the essential part of a pressure booster in the second embodiment of the present invention. Like parts are indicated by like numerals used in FIG. 3. In FIG. 4, numeral 120 refers to a hydraulic cylinder integrally formed by a first cylinder 121 connected directly on the same axial line to a second cylinder 122 having a cross-sectional surface area larger than that of the first cylinder 121. The first cylinder 121 and the second cylinder 122 have a first piston 123 and a second piston 124, respectively, each provided slidably therein.

Numeral 125 refers to a protruding part integrally formed on the upper part of the second piston 124, with the axial length thereof made smaller than the stroke of the first piston 123. The protruding part 125 is tightly slidably engaged with the first cylinder 121. Numeral 126 refers to a bottom plate formed into a flat ring shape, for example, and fixedly fitted to the support plate 115 on the bottom part of the hydraulic cylinder 120 via bolts 127. On sliding parts between the hydraulic cylinder 120 and the first piston 123, between the first piston 123 and the first cylinder 121 of the protruding part 125, between the second piston 124 and the second cylinder 122, and between the bottom plate 126 and the second piston 124 provided are wear rings, O rings and other appropriate sealing means, respectively. The first piston 123 is connected to the slider 104 shown in FIG. 3, whereas the second piston 124 is connected to the movable die 111.

With the aforementioned construction, when the servo motor 106 as shown in FIG. 3 is driven, the threaded shaft 107 is caused to rotate, the nut member 105 and the slider 104 to descend, and the first piston 123 as shown in FIG. 4 to descend. As a result, an actuating force is exerted onto the second piston 124 via the hydraulic oil in the first cylinder 121 and the second cylinder 122, and a predetermined press working is carried out as the movable die 111 descends. Upon completion of press working, the servo motor 106 is reversed, causing the nut member 105 and the slider 104 to ascend. Thus the first piston 123 ascends, and the second piston 124 and the movable die 111 ascend to return to the original position.

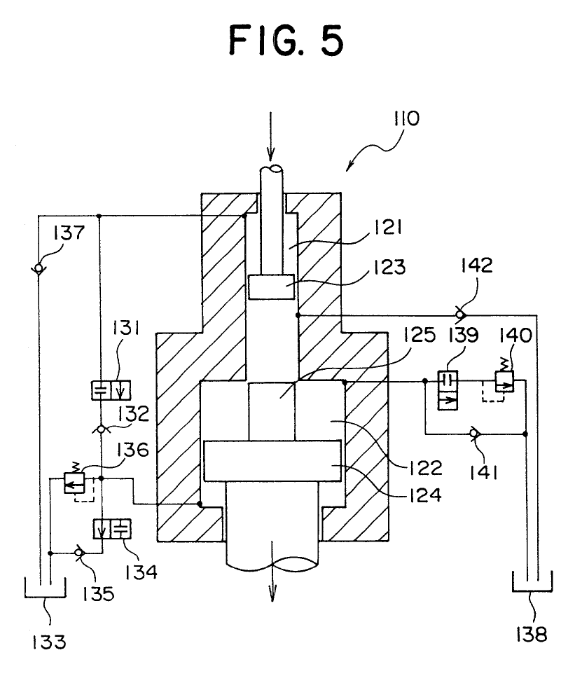

FIGS. 5 through 10 are diagrams of assistance in explaining the operating state of the pressure booster. Like parts are indicated by like numerals used in FIG. 4. In FIGS. 5 through 10, numerals 131 and 132 refer to a changeover valve and a check valve, installed in series between outer ends of the first cylinder 121 and the second cylinder 122, respectively. Between the outer end of the second cylinder 122 and an oil tank 133 directly connected are a changeover valve 134 and a check valve 135, and a pressure regulating valve 136 in parallel with the changeover valve 134 and the check valve 135. Numeral 137 refers to a check valve provided in series between the outer end of the first cylinder 121 and the oil tank 133.

Between the neighborhood of the part communicating the second cylinder 122 to the first cylinder 121 and the oil tank 138 provided are a changeover valve 139 and a pressure regulating valve 140 both connected in series, and a check valve 141 disposed in parallel with the changeover valve 139 and the pressure regulating valve 140. Numeral 142 refers to a check valve connected between the middle part of the first cylinder 121 and the oil tank 138.

In FIG. 5, both the first piston 123 and the second piston 124 are at the top dead-center positions thereof, from which the first piston 123 is caused to descend via the servo motor 106, the threaded shaft 107, the nut member 105, and the slider 104, shown in FIG. 3. In this case, the changeover valves 131 and 139 are closed, and the changeover valve 134 opened.

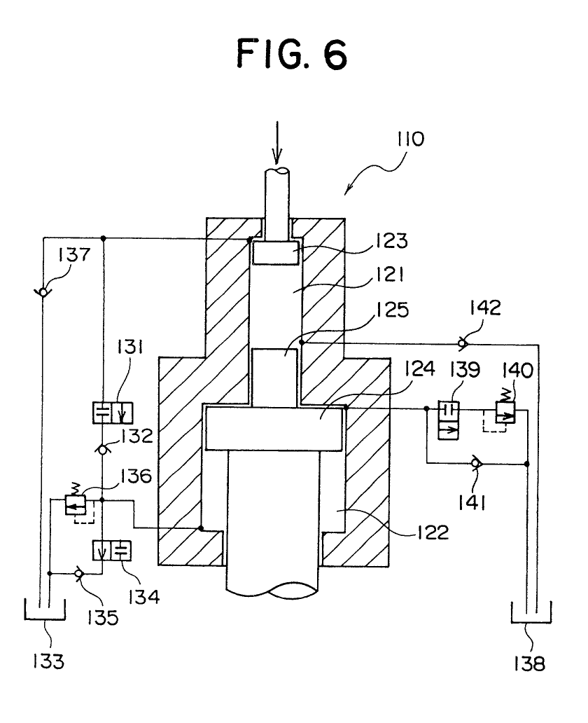

FIG. 6 shows the state where the first piston 123 and the second piston 124 are descending. That is, the pressure in the first cylinder 121 rises as the result of the descending of the first piston 123, thereby the protruding part 125 tightly fitted into the first cylinder 121 is forced downward, and the second piston 124 descends at almost the same speed as the first piston 123 until the upper end of the protruding part 125 reaches the part communicating the first cylinder 121 to the second cylinder 122.

In this case, hydraulic oil is fed to the first cylinder 121 above the first piston 123 from the oil tank 133 via the check valve 137, while the hydraulic oil in the second cylinder 122 below the second piston 124 is discharged into the oil tank 133 via the changeover valve 134 and the check valve 135. Hydraulic oil is fed from the oil tank 138 to the second cylinder 122 above the second piston 124 via the check valve 141.

As the upper end of the protruding part 125 integrally provided on the upper part of the second piston 124 moves downward away from the part communicating the first cylinder 121 to the second cylinder 122, the pressure onto the hydraulic oil in the first piston 123 is applied onto the entire upper end surface of the second piston 124. As a result, an actuating force corresponding to the ratio of the cross-sectional surface areas of both can be applied on the second piston 124, thereby operating the movable die 111 shown in FIG. 3 with a predetermined large actuating force. As long as the large actuating force is kept applied, the hydraulic oil in the second cylinder 122 is sealed inside the second cylinder 122 because the changeover valve 139 is closed and by the action of the check valve 141, and the pressure of the hydraulic oil can be boosted to a predetermined pressure by the first piston 123.

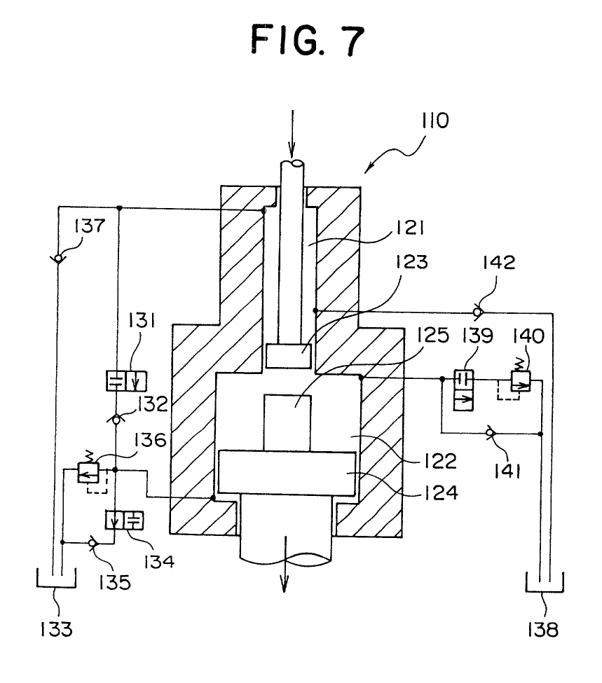

FIG. 7 shows the state where the first piston 123 and the second piston 124 reach the bottom dead-center position thereof.

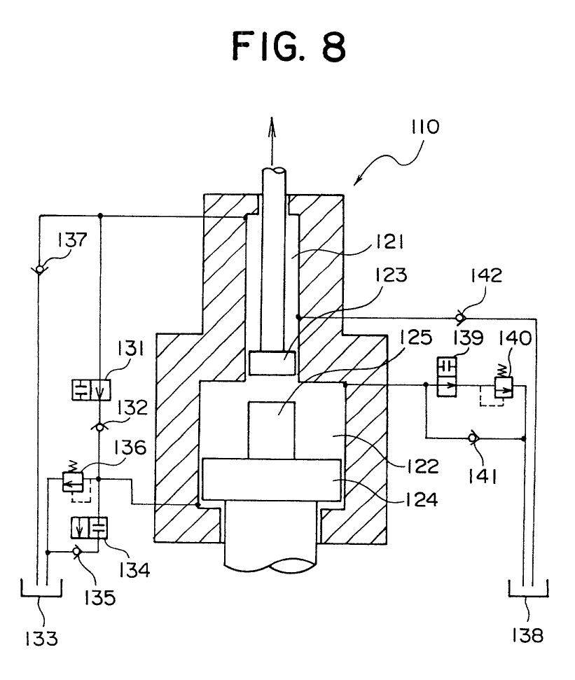

FIG. 8 shows the state where the first piston 123 and the second piston 124 start ascending. That is, the changeover valves 131 and 139 are opened, and the changeover valve 134 closed. Then, the first piston 123 is caused to ascend by operating the drive means in the reverse direction.

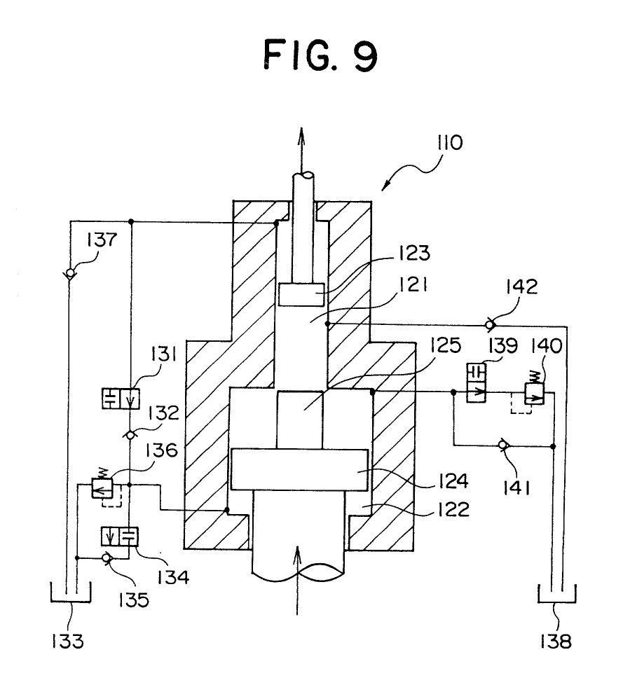

FIG. 9 shows the state where the first piston 123 and the second piston 124 are ascending. In this case, as the first piston 123 ascends, the hydraulic oil in the first cylinder 121 above the first piston 123 flows into the second cylinder 122 below the second piston 124 via the changeover valve 131 and the check valve 132, whereas the hydraulic oil in the second cylinder 122 above the second piston 124 is discharged to the oil tank 138 via the changeover valve 139 and the pressure regulating valve 140.

The hydraulic oil in the first cylinder 121 above the first piston 123 flows into the second cylinder 122 below the second piston 124 via the changeover valve 131 and the check valve 132. As a result, the first piston 123 ascends, and the second piston 124 also ascends.

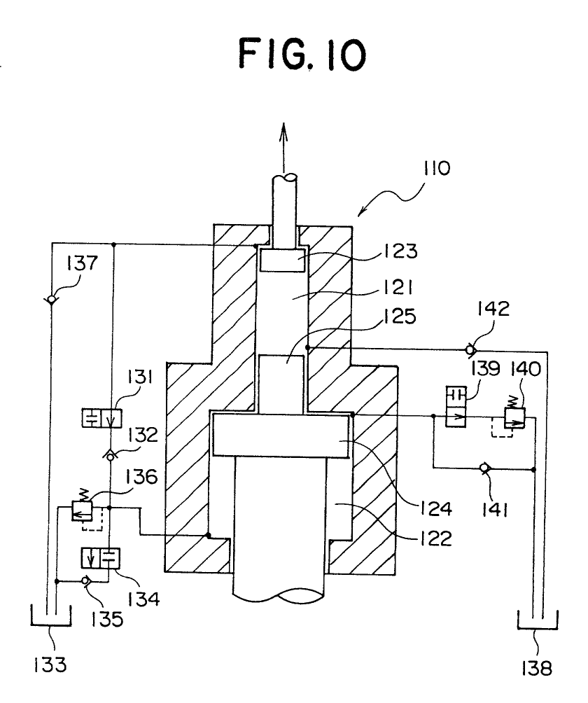

FIG. 10 shows the state where the first piston 123 and the second piston 124 are returned to the top dead-center position upon completion of ascending. After the second piston 124 has ascended from the state shown in FIG. 9, and the protruding part 125 integrally provided on the upper end thereof has reached the part communicating the first cylinder 121 to the second cylinder 122, the second piston 124 ascends at almost the same speed as the first piston 123. Even after the second piston 124 has reached the top dead-center position thereof, if the first piston 123 ascends further, the hydraulic oil above the first piston 123 is further discharged into the oil tank 133 via the pressure regulating valve 136, and hydraulic oil is supplied to the first cylinder 121 from the oil tank 138 via the check valve 142. With this, the state shown in FIG. 5 is brought about, and the above operation is repeated thereafter.

Although description has been made about an example of hydraulic oil-operated hydraulic cylinders in the above second embodiment, water and other appropriate fluids can be used instead. Furthermore, description has also been about the so-called vertical type where the base plate 101 and the support plate 103 are disposed in parallel with the horizontal plate, with the guide bar 102 connecting both provided in the vertical direction. The present invention, however, can also be applied to the so-called horizontal type where the base plate 101 and the support plate 103 are provided in parallel with the vertical plane, with the guide bar 102 provided in the horizontal direction.

Although the present invention is particularly effective for the construction where the threaded shaft 107 and the nut member 105 are connected with a ball-screw engagement, the present invention can also be applied to a construction where both are connected with a standard screw engagement. Needless to say, the threaded shaft 107 may be of a multiple-start type, including the ball-screw engagement. Although the most common configuration is such that the servo motor 106 for driving the threaded shaft 107 is coaxially connected directly to the threaded shaft 107 is most common, drive force may be transmitted with gears, timing belts and other transmission means.

In the above embodiment, description has been made about the construction where the threaded shaft 107 is driven to move the slider 104. There can be a construction, however, where the threaded shaft 107 is fixedly fitted to the slider 104, and the nut member 105 screwed to the threaded shaft 107 is driven by the servo motor 106. A crank mechanism may be used as means for driving the slider 104.

Furthermore, the guide bar 102 for guiding the movement of the slider 104 should preferably be more than one for large machines or those requiring rigidity, but a single piece of guide bar 102 may serve the purpose. The guide bar 102 may be formed into a columnar or beam shape, or may have such a construction that the slider 104 slides along the side surface of the guide bar 102.

In addition, the press working apparatus of the present invention that is originally used singly, can be applied to an indexing machining of a long-sized workpiece, for example, by disposing a plurality of the press working apparatuses in tandem. The press working apparatus of the present invention can be used for assembling, press-fitting and crimping a plurality of parts, in addition to the sheet metal working of sheet materials.

The second embodiment of the present invention has the following effects:

(A) The second piston 124 descends at the same descending speed as the first piston 123 until the upper end of the protruding part 125 integrally provided on the upper part of the second piston 124 clears the part communicating the first cylinder 121 to the second cylinder 122, moving downward. That is, hydraulic oil is supplied from the oil tank 138 into the cavity of the second cylinder 122 above the second piston 124 via the check valve 141 because the pressure in the cavity lowers during the period. In addition, hydraulic oil is discharged from the cavity of the second cylinder below the second piston 124 into the oil tank 133 via the changeover valve 134 and the check valve 141 during the period. As a result, the second piston 124 descends at the same speed as the first piston 123.

(B) When the upper end of the protruding part 125 clears the part communicating the first cylinder 121 to the second cylinder 122, moving downward, the pressure in the cavity of the second cylinder 122 above the second piston 124 increases in accordance with the descending of the first piston 123. Thus, the check valve 141 is closed, interrupting the supply of hydraulic oil from the oil tank 138. As a result, the descending speed of the second piston 124 becomes sufficiently lower than the descending speed of the first piston 123, whereas the actuating force of the second piston 124 to push the movable die 111 become sufficiently larger.

The second embodiment has a construction that the protruding part 125 is provided on the upper part of the second piston 124, and the oil tanks 133 and 138 are provided outside of the apparatus.

The construction where the oil tanks 133 and 138 are provided externally is not necessarily desirable. Increasing the pushing force automatically when pushing a work piece in actual operation by appropriately adjusting the pressure in the cavity of the second cylinder 122 above the second piston 124 in the second embodiment should be more preferable. In the following, the third embodiment of the present invention will be described.

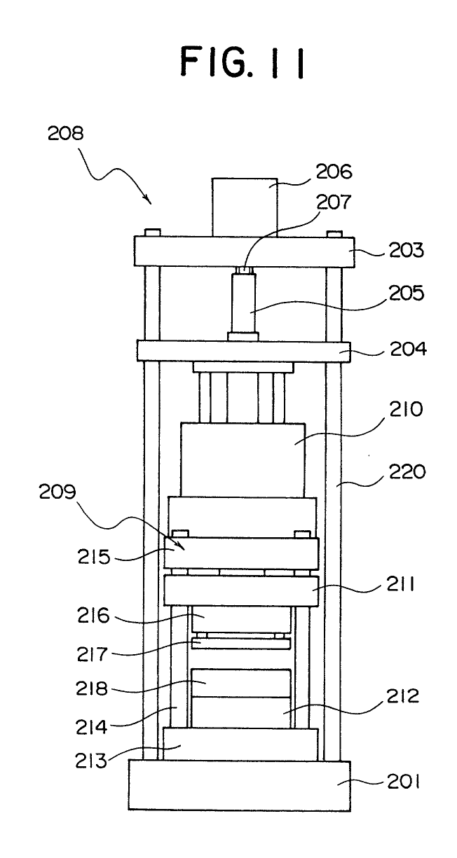

FIG. 11 is a front view showing the essential part of the third embodiment of the present invention. In FIG. 11, guide bars 202 are provided upright at the four corners of a base plate 201 formed into a rectangular shape, for example, and a support plate 203 is fixedly fitted to the upper ends of the guide bars 202 via appropriate fastening means. Numeral 204 refers to a slider vertically slidably provided on the guide bars 202. Numeral 205 refers to a nut member integrally provided on the central upper surface of the slider 204 and engaged with a threaded shaft 207 connected to the main shaft of a servo motor 206 provided on the upper surface of the support plate 203. In this case, the threaded shaft 207 and the nut member 205 should preferably constitute a ball-screw mechanism. These components arranged in the aforementioned construction constitute the body 208 of the press working apparatus.

Next, numeral 209 refers to a presswork unit having a pressure booster 210 whose construction will be described later, a movable die 211 and a fixed mold 212, both detachable provided between the base plate 201 and the slider 204. The presswork unit 209 has such a construction that a presswork unit support plate 215 is fixedly fitted on the upper ends of presswork unit guide bars 214 provided upright at the four corners of a presswork unit base plate 213 formed into a rectangular shape, for example, and a pressure booster 210 is provided on the presswork unit support plate 215.

The pressure booster 210 is driven by the vertical movement of the slider 204, as will be described later, to operate the movable die 211. The movable die 211 may be adapted to be preloaded upward by a spring (not shown), for example, or other appropriate means. A punch pad 216 and a stripper 217, and dies 218, for example, are detachably provided on the movable die 211 and the fixed die 212.

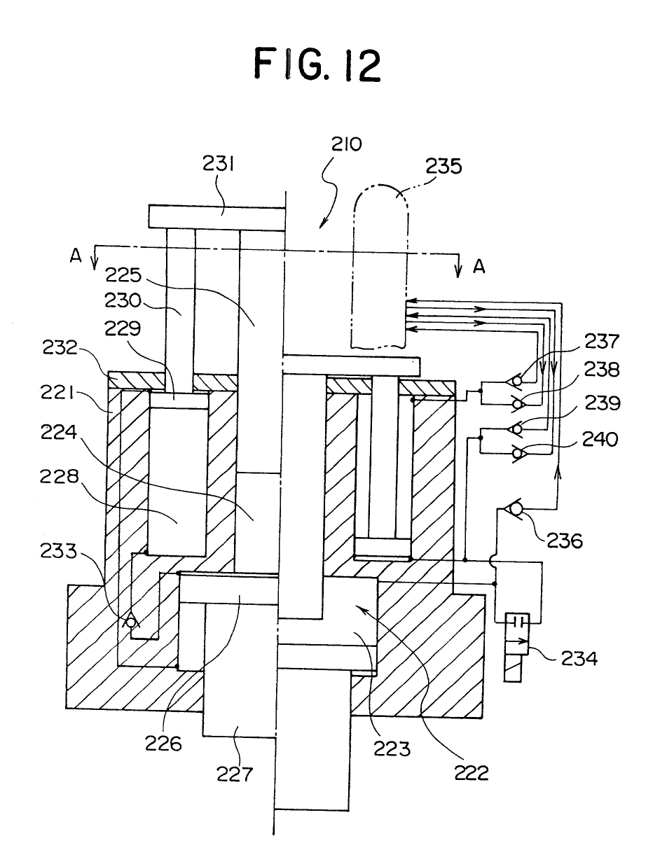

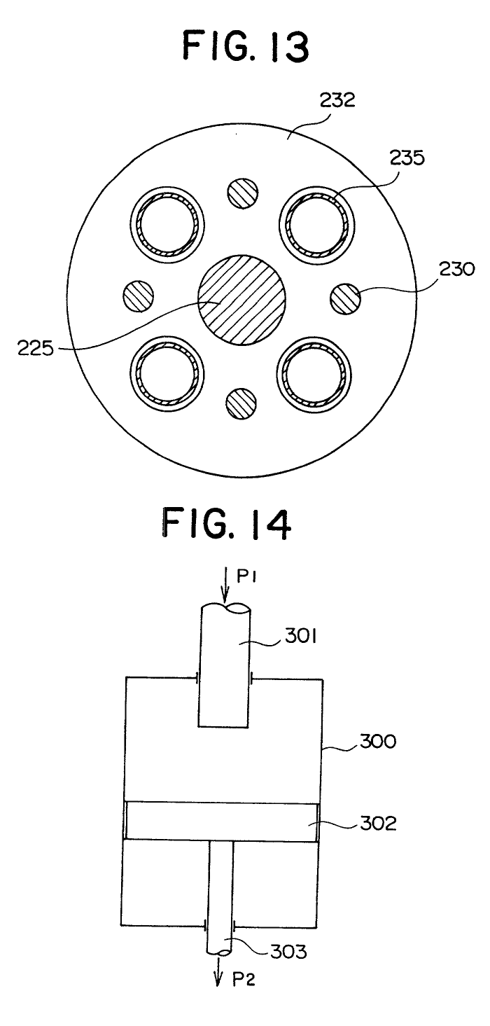

FIG. 12 is an enlarged longitudinal sectional view showing the essential part of the pressure booster in the third embodiment of the present invention, the left side of the centerline showing the upper end position of the movable member, and the right side showing the lower end position of the movable member. FIG. 13 is a cross-sectional view taken substantially along line A-A in FIG. 12. In FIGS. 12 and 13, numeral 221 refers to a hydraulic cylinder formed into a hollow cylindrical shape, for example, with cylinder cavities 223 and 224 constituting an actuating cylinder 222 provided at the central part thereof in such a manner as to communicate to each other. The cylinder cavities 223 and 224 should preferably be formed coaxially, but may be formed in a slightly staggered manner. In the cylinder cavities 223 and 224 vertically slidably provided are a plunger 225 and an actuating piston 226, facing each other; the rod 227 of the actuating piston 226 protruding downward from the hydraulic cylinder 221. The cylinder cavity 224 corresponds with what is referred to as the first cylinder in the present invention, the plunger 225 corresponds with the first piston, the cylinder cavity 223 with the second cylinder, and the actuating piston 226 with the second piston, respectively.

Next, numeral 228 refers to a pump cylinder formed as having an axial line parallel with the axial line of the actuating cylinder 222, for example; four pump cylinders 228, for example, being provided at equal circumferential intervals on the upper half of the hydraulic cylinder 221 in such a manner that the axial lines exist on the same circumference. In the pump cylinder 228s vertically slidably provided are pump pistons 229, with the rods 230 thereof protruding upward. Numeral 231 refers to a support plate that supports the upper ends of the plunger 225 and the rods 230 in such a manner that they can be moved simultaneously.

Numeral 232 refers to a lid member provided on the upper end of the hydraulic cylinder 221 for closing the top open part of the cylinder cavity 224 and the pump cylinder 228. O rings, packing, and other appropriate sealing means (not shown) are provided on the sliding part of the actuating piston 226 and the pump piston 229 with the cylinder cavity 223 and the pump cylinder 228, and on the sliding part of the upper and lower ends of the hydraulic cylinder 221 and the lid member 232 with the plunger 225 and the rods 227 and 230. The support plate 231 is connected to the slider 204 shown in FIG. 11, and the rod 227 of the actuating piston 226 is formed in such a manner as to engage with the movable die 211 of the presswork unit 209 shown in FIG. 11.

Next, the ends on the sides of the rods 227 and 230, respectively, of the cylinder cavity 223 and the pump cylinder 228 are connected in such a manner as to allow fluid to flow therein, and the ends on the sides of the actuating piston 226 and the pump piston 229 of the cylinder cavity 223 and the pump cylinder 228 are connected via the check valve 233 and the changeover valve 234 provided in parallel. The end on the side of the actuating piston 226 of the cylinder cavity 223 is connected to the accumulator 235 via the check valve 236, and the end on the side of the rod 230, the end on the side of the pump piston 229 of the pump cylinder 228 and the accumulator 235 are connected via the check valves 237 and 238 and the check valves 239 and 240 provided in parallel, respectively.

The accumulator 235 can be formed into a shape of a cylinder having a closed cavity, for example, with four units of the accumulators 235 provided on the lid member 232 at equal intervals on the same circumference. In this case, appropriate notches or openings are provided on the support plate 231 and the slider 204 shown in FIG. 11 at locations corresponding to the accumulator 235 to prevent interference. The accumulator 235 may be provided independently of the hydraulic cylinder 221, or between the pump cylinders 228 and 228, for example, inside the pressure booster 210.

With the above construction, when the threaded shaft 207 is caused to rotate by the operation of the servo motor 206 shown in FIG. 11, the slider 204 is moved downward via the nut member 205 engaged with the threaded shaft 207. That is, in FIG. 12, the downward movement of the support plate 231 connected to the slider 204 shown in FIG. 11 causes the plunger 225, the rod 230 and the pump piston 229 to move downward. In such a case, the changeover 234 is kept closed as shown in FIG. 12.

As the plunger 225 and the pump piston 229 are moved downward from the state shown on the left side of the centerline in FIG. 12, the hydraulic oil in the cylinder cavity 224 is supplied into the cylinder cavity 223 above the actuating piston 226, and the hydraulic oil in the pump cylinder 228 is also supplied into the cylinder cavity 223 via the check valve 233. As a result, the actuating piston 226 is moved downward. The downward movement of the actuating piston 226, on the other hand, is carried out smoothly since the hydraulic oil below the actuating piston 226 flows up above the pump cylinder 228, with the result that the actuating piston 226 smoothly moves downward. When the actuating piston 226 moves along a predetermined distance, the rod 227 actuates the movable die 211 shown in FIG. 11 to perform a prescribed press work.

In this case, the traveling speed of the actuating piston 226 is almost the same as the descending speed of the plunger 225 and relatively large because a relatively large amount of hydraulic oil is fed into the cylinder cavity 223. When a load is exerted onto the rod 227 and the actuating piston 226 from below as the result of the operation of the movable die 211, the lowering of the plunger 225 causes the pressure of the hydraulic oil above the actuating piston 226 to rise up to a pressure (250 kg/cm², for example) set by the check valve 236. As a result, the actuating force transmitted to the actuating piston 226 and the rod 227 becomes a larger actuating force corresponding to the ratio of the cross-sectional areas of the plunger 225 and the actuating piston 226, actuating the movable die 211 shown in FIG. 11.

The rod 230 and the pump piston 229 are also moved downward along with the downward movement of the plunger 225, as described above. When the pressure in the cylinder cavity 223 above the actuating piston 226 rises, the hydraulic oil below the pump piston 229 is prevented from flowing into the cylinder cavity 223, diverted to the accumulator 235 via the check valve 239 and stored there. Thus, the plunger 225 smoothly moves downward to a state shown on the right side of the centerline in FIG. 12, with the result that the pressure of the hydraulic oil in the cylinder cavity 223 is boosted. The pressure set in the check valve 239 is set to a value lower than the pressure in the check valve 236, say, 5 kg/cm².

Now, the process of returning to the original state from the state shown on the right side of the centerline in FIG. 12 will be described. In the above state, the reverse operation of the servo motor 206 shown in FIG. 11 causes the plunger 225, the rod 230 and the pump piston 229 to ascend via the support plate 231, and at the same time changes the changeover valve 234 to the open state.

The ascension of the plunger 225 causes the pressure of the hydraulic oil in the cylinder cavity 223 above the actuating piston 226 to drop, whereas the ascension of the pump piston 229 feeds the hydraulic oil in the pump cylinder 228 above the pump piston 229 to the cylinder cavity 223 below the actuating piton 226, causing the actuating piston 226 to ascend.

In this case, since the hydraulic oil in the cylinder cavity 223 above the actuating piston 226 flows into the pump cylinder 228 below the pump piston 229 via the changeover valve that is turned into the open state, the plunger 225 and the pump piston 229 ascends smoothly, returning to the state on the left side of the centerline in FIG. 12.

The shortfall of hydraulic oil due to consumption and leaks is replenished into the pump cylinder 228 from the accumulator 235 via the check valves 238 and 240 along with the vertical movement of the pump piston 229. This also ensures the smooth vertical movement of the plunger 225, the pump piston 229 and the actuating piston 226.

In the aforementioned third embodiment, description has been made about the plunger 225, the rod 230 and the pump piston 229 all of which are moved vertically in synchronism with each other. There can be an arrangement where the rod 230 and the plunger 225 are allowed to move slightly relatively by installing the rod 230 on the support plate 231 via a spring, etc. The preset pressure values to be given to the check valves 233, and 236˜240 can be selected appropriately taking into account the actuating force to be exerted onto the presswork unit 209.

In the foregoing, description has also been made about the actuating piston 226 and the rod 227 both of which are solid. There can be an arrangement where the actuating piston 226 and the rod 227 are formed into a bottomed hollow cylindrical shape or a shape having a recess with an opening at the upper part thereof so that the lower end of the plunger 225 can advance into the hollow part or the recess of the actuating piston 226 and the rod 227 with a predetermined interval. With this arrangement, the strokes of the actuating piston 226 and the rod 227 can be made larger.

In the foregoing, description has also been made on hydraulic cylinders operated by hydraulic oil, but water or other appropriate fluids can be used. Description has also been made on the so-called vertical type where the base plate 201 and the support plate 203 are disposed in parallel with the horizontal plane, and the guide bar 202 connecting both being provided in the vertical direction. The present invention can also be applied to the so-called horizontal type where the base plate 201 and the support plate 203 are disposed in parallel with the vertical plane with the guide bar 202 provided in the horizontal direction.

The present invention is particularly effective when used with the threaded shaft 207 and the nut member 205 connected with the ball-screw engagement, but it can be applied to the normal screw engagement to connect both. Needless to say, the method of connecting the threaded shaft 207 and the nut member 205 can be multiple-start type, including the ball-screw engagement. Although the most common construction of the servo motor 206 for driving the screw shaft 207 is that of coaxially connecting the servo motor 206 with the threaded shaft 207, drive power can be transmitted via gears, timing belts or other appropriate transmission means.

In the aforementioned embodiments, description has been made on the construction where the thread shaft 207 is driven to move the slider 204. There can be an arrangement where the threaded shaft 207 is fixedly fitted to the slider 204, and the nut member 205 screwed to the threaded shaft 207 is driven by the servo motor 206. Furthermore, a crank mechanism can be used as a means for driving the slider 204.

The guide bar 202 for guiding the movement of the slider 204 should preferably be more than one for a unit of a large size or requiring rigidity, but a single guide bar may serve the purpose. In some cases, the guide bar 202 may be of a columnar or beam shape on the surface of which the slider 204 slides.

Moreover, the press working apparatus of the present invention can be applied not only to a single-unit operation but also to an index-feed processing, or a progressive-die processing operation, where a long-sized workpiece, for example, is processed on a plurality of press working apparatuses arranged in tandem. The press working apparatus can be used not only for sheet metal working but also for assembly, press-fitting, crimping and other processing of a plurality of parts.

The third embodiment of the present invention can achieve the following effects.

1) The stroke of the movable die required for the presswork unit can be made relatively larger, allowing the unit to move at a relatively higher speed particularly in a range where a small actuating force is needed, and to generate a larger actuating force in the final stage involving a relatively short stroke.

2) A predetermined large actuating force can be produced at any position between the initial and final positions of movable members where the actuating piston 226 and the rod 227 receive a load from beneath due to the existence of a workpiece.

3) Energy consumption is extremely small because an extremely small amount of hydraulic oil, for example, is needed to operate the apparatus and there is no need for supplying high-pressure hydraulic oil for hydraulic units.

Industrial Applicability

The present invention having the aforementioned construction and operation can accomplish the following effects.

1) The stroke of a movable die, for example, in a press working apparatus can be made larger.

2) When a workpiece, for example, is stumped, a sufficiently large pressure can be exerted taking advantage of Pascal's law.

3) In the third embodiment, the rod 227 connected to the actuating piston 226 advances at a relatively high speed until the rod 227 comes to press a workpiece, and an actuating force for automatically pushing the workpiece can be made larger only when the rod begins pushing the workpiece.

What is claimed is:

1. A pressure booster using a working fluid
comprising a first cylinder and a second cylinder having a larger cross-sectional area than the cross-sectional area of the first cylinder;
the first and second cylinders connected to each other,
a first piston slidably fitted to the first cylinder,
a second piston slidably fitted to the second cylinder,
the downstream-side surface of the first piston and/or the upstream-side surface of the second piston being formed in such a shape that fluid pressure can be exercised via the working fluid only onto part of the upstream-side surface of the second piston during the period when the downstream-side surface of the first piston moves in unit of time in a first stroke stage where the first piston moves, and
fluid pressure being exercised via the working fluid onto the substantially entire upstream-side surface of the second piston corresponding to the cross-sectional area during the period when the downstream-side surface of the first piston moves in a second stroke stage where the first piston moves.

2. A pressure booster using a working fluid
comprising a first cylinder and a second cylinder having a larger cross-sectional area than the cross-sectional area of the first cylinder;
the first and second cylinders connected to each other,
a first piston slidably fitted to the first cylinder,
a second piston slidably fitted to the second cylinder,
the working fluid being fed into a cavity on the upstream-side surface of the second piston corresponding to a size in which the volume generated by the movement of the upstream-side surface of the second piston in unit of time in the first stroke stage where the first piston moves becomes larger than the volume generated by the movement of the downstream-side surface of the first piston in unit of time, and
the working fluid in a cavity in contact with the downstream-side surface of the first piston and the cavity in contact with the upstream-side surface of the second piston being sealed after both the cavities are connected to each other so that the volume generated by the movement of the downstream-side surface of the first piston in unit of time become substantially equal to the volume generated by the movement of the upstream-side surface of the second piston in unit of time in a second stroke stage where the first piston moves.

3. A press working apparatus having a pressure booster driven by a drive means on a substrate;
the pressure booster comprising a hydraulic cylinder, a plunger fitted to the hydraulic cylinder and formed movably in the axial direction of the hydraulic cylinder, and a bottomed hollow actuating cylinder,
an end of the plunger being connected to the drive means,
the bottom end of the actuating piston being protruded from the end of the hydraulic cylinder and formed in such a manner that the bottom end can be engaged with a workpiece being pressed,
a protruding part having an axial length shorter than the stroke of the actuating piston being provided at the center of an open end of the actuating piston; the protruding part being formed slidably in a tightly sealed state with respect to a sliding part formed on part of the inside surface of the hydraulic cylinder in such a manner as to have essentially the same axial length as the axial length of the protruding part,
the hollow part of the actuating piston being formed in such a manner that the plunger can advance into the hollow part with a gap, and
the plunger and the piston being driven by the movement of the drive means to the side of the workpiece being pressed to actuate the workpiece being pressed via the fluid in the plunger and the hydraulic cylinder, and the actuating piston.

4. A press working apparatus as set forth in claim 3 wherein a plurality of tubular rods provided in such a manner as to protrude on the end face of the piston on the side of the drive means; driving rods being fitted inside the tubular rods in such a manner as to be relatively movable in the axial direction of the tubular rods, and an end of the driving rods being connected to the drive means so that the piston can be driven via the driving rods.

5. A press working apparatus as set forth in claim 3 wherein a changeover valve, a pressure regulating valve and a check valve are provided in parallel with each other between cavities of hydraulic cylinders on the side of the inner end surfaces thereof where the piston and the actuating piston face each other; cavities of the hydraulic cylinders on the side of the outer end surfaces of the piston and the actuating piston being formed in such a manner that a fluid can flow therethrough, and a check valve being provided between the hydraulic cylinder cavity on the side of the inner end surface of the actuating piston and the hollow part of the actuating piston.

6. A press working apparatus as set forth in claim 3 wherein the cavity of the hydraulic cylinder to which the piston is fitted is connected to a fluid tank via a check valve.

7. A press working apparatus as set forth in claim 3 wherein the base plate is disposed in parallel with the horizontal plane, and the driving part of the drive means is provided movably in the vertical direction.

8. A press working apparatus as set forth in claim 3 wherein the drive means comprises a servo motor and a screw pair.

9. A press working apparatus as set forth in claim 3 wherein the screw pair comprises a ball screw.

10. A press working apparatus as set forth in claim 3 wherein the driving part of the drive means is formed in such a manner that the driving part slides along the base plate and a guide bar provided above the base plate.

11. A press working apparatus having a pressure booster wherein the pressure booster comprises
a first cylinder and a second cylinder that has a larger cross-sectional area than the cross-sectional area of the first cylinder and is connected to the first cylinder;
a first piston being slidably fitted to the first cylinder,
a second piston being slidably fitted to the second cylinder,
a protruding part having an axial length shorter than the stroke of the first piston being integrally provided on the second piston; the protruding part being slidably engaged with the first cylinder with no space therebetween, and
an actuating force larger than the actuating force of the first piston is exerted onto the second piston by the action of the first piston via hydraulic fluids in the first and second cylinders.

12. A press working apparatus as set forth in claim 11 wherein outer ends of the first and second cylinders are formed in such a manner as to be selectively connected via a changeover valve and a check valve.

13. A press working apparatus as set forth in claim 11 wherein a changeover valve and a check valve are provided in parallel between the vicinity of the connecting part of the first and second cylinders and a fluid tank.

14. A press working apparatus as set forth in claim 11 wherein the press working apparatus proper comprises a base plate, a slider provided facing the base plate and slidably formed in the direction orthogonal to the base plate and a drive means for driving the slider; a pressure booster being provided between the base plate and the slider, and a presswork unit comprising a movable die and fixed die being detachably provided, the first and second pistons constituting the pressure booster each being connected to the slider and the movable die, and the presswork unit being operated by the movement of the slider toward the presswork unit via the pressure booster.

15. A press working apparatus as set forth in claim 11 wherein the base plate and the support plate are provided in parallel with the horizontal plane, and the slider provided movably in the vertical direction.

16. A press working apparatus as set forth in claim 11 wherein the drive means comprises a mechanism including a servo motor and a screw pair.

17. A press working apparatus as set forth in claim 11 wherein the screw pair comprises a ball screw.

18. A press working apparatus as set forth in claim 11 wherein the slider is formed slidably along a guide bar provided between the base plate and the support plate.

19. A press working apparatus having a pressure booster wherein the pressure booster comprises an actuating cylinder, a pump cylinder, a plunger and an actuating piston both fitted on the actuating cylinder facing each other, and a pump piston fitted to the pump cylinder;
an end of the plunger being connected to the rod of the pump piston,
the rod of the actuating piston being formed in such a manner as to be engaged with a workpiece being pressed,
the plunger and the pump piston being driven by the movement of the drive means toward the workpiece being pressed,
working fluid being allowed to flow, or prevented from flowing, in the actuating cylinder, and
the workpiece being pressed is operated via the plunger, the fluid in the actuating cylinder and the actuating piston.

20. A press working apparatus as set forth in claim 19 wherein
the ends on the rod side of the actuating cylinder and the pump cylinder are connected in such a manner as to allow the working fluid to communicate through both,
the ends on the piston side of the actuating cylinder and the pump cylinder are connected via a check valve and a changeover valve provided in parallel,
the end on the piston side of the actuating cylinder, and the ends on the rod and piston sides of the pump cylinder, and an accumulator are connected via independent check valves.

21. A press working apparatus as set forth in claim 19 wherein the drive means comprises a mechanism including a servo motor and a screw pair.

22. A press working apparatus as set forth in claim 19 wherein the screw pair comprises a ball screw.
